(19) United States
(12) Patent Application Publication
(10) Pub. No.: US 2024/0066845 A1
(43) Pub. Date: Feb. 29, 2024

(54) LAMINATED MONOMATERIAL POLYETHYLENE FILM

(71) Applicant: SABIC Global Technologies B.V., Bergen op Zoom (NL)

(72) Inventors: Lanya Cheng, Shanghai (CN); Bart Albertus Hubertus van den Esschert, Sittard (NL); Hang Lu, Shanghai (CN); Maria Soliman, Selfkant (DE); Niclasina Siberta Johanna Alberdina Gerrits, Sittard (NL)

(21) Appl. No.: 18/267,587

(22) PCT Filed: Nov. 26, 2021
(86) PCT No.: PCT/EP2021/083157

§ 371 Date: Jun. 15, 2023

(30) Foreign Application Priority Data
Dec. 17, 2020 (WO) PCT/CN2020/137286

(51) Int. Cl. B32B 27/08; B31B 70/64; B32B 27/32; B65D 65/40

(52) U.S. Cl. CPC B32B 27/08; B31B 70/64; B32B 27/32; B65D 65/40; B31B 2155/00; B32B 2250/03; B32B 2250/242; B32B 2307/31; B32B 2307/518; B32B 2307/54; B32B 2307/558; B32B 2307/581; B32B 2307/5825; B32B 2307/72; B32B 2307/748; B32B 2439/46; B32B 2439/70

(57) ABSTRACT

The present invention relates to a laminated polyethylene film comprising: (a) a first film; and (b) a second film; wherein the first and the second film are adhering to one another to form a laminate; wherein ⋅ the first film is a bi-directionally oriented film; and ⋅ the second film is a blown film; wherein the first film comprises or consists of polyethylene, and the second film comprises or consists of polyethylene; wherein the second film comprises one or more film layers, and comprises a sealing layer so that the sealing layer forms a surface layer of the laminated film; wherein the sealing layer comprises a polyethylene copolymer (I) comprising moieties derived from 1-octene, having: ⋅ a density of ≥855 kg/m3 and ≤910 kg/m3, as determined in accordance with ASTM D792 (2008); ⋅ a melt mass-flow rate of ≥0.2 and ≤5.0 g/10 min, as determined in accordance with ASTM D1238 (2013) at a temperature of 190° C. under a load of 2.16 kg. Such laminated film, constituting a mono-material, mechanically recyclable packaging film solution, demonstrates a desirably low sealing temperature whilst ensuring good seal strength. This enables use in thermally sealed food packages, with reduced sealing energy consumption and reduced exposing of package contents to high temperatures, leading to increase of shelf life of the packed foodstuff. Moreover, the mechanical properties of the laminate are of desirably high level.

The present invention relates to a laminated polyethylene film having improved sealing properties.

In the field of packaging, polyethylene materials are ubiquitously employed, due to their versatility and appropriate material properties that allow them to be used in a wide variety of applications, including food packaging applications. Use of polyethylene materials greatly contributes to a.o. food safety by allowing hygienic packaging of food products, and contributes significantly to reduction of wasting valuable food products due to increasing the shelf life of the food products.

In the field of packaging materials, presently an important driver is emerging relating to reduction of environmental footprint of the materials. Industry is engaged in great efforts to mitigate this. Particular methods by means of which this is sought to be achieved is by reduction of the energy consumption that is associated with packaging, by reduction of the quantity of material that is used in packaging, and by increasing the recyclability of the materials into products of preferably equal value as had those used in the packaging application that is gathered for recycling.

To facilitate recyclability, a particular method that is gaining traction is to strive for use of plastic materials in a package that belong to a single family of thermoplastics. In conventional packages, different types of plastics are commonly employed in conjunction, as a result of product optimisation driven by the packaging quality requirements. For example, thermoplastic films that are commonly used in packaging solutions may well comprise multiple co-extruded layers, or laminated layers, wherein such layers can comprise polymeric materials of very different chemical structure. For example, a multi-layer laminate may comprise polyethylene material in one layer, and a polyester such as polyethylene terephthalate in another layer. Now, by this practise, it is possible to produce certain films having the particularly desirable material properties. However, such films comprising multiple different materials tend to pose difficulty when it comes to recycling of the films. When subjected to mechanical recycling, such processing is commonly done via melt processing, forming a melt compounded mixture of the constituent plastic materials as present in the blend of materials offered for recycling. When such melt compounded mixture contains plastics of very different chemical nature, this leads to poor mechanical properties of the product produced using the recycled material. The more uniform the composition of the blend of recycle thermoplastic materials, the more suitable that material is for further use in high-value high-quality products, thereby reducing the so-called down-cycling of materials, which leads to ever lower value use of recycle materials.

Hence, there is a desire to provide objects comprising thermoplastic materials, such as plastic packages, of such nature that the thermoplastic materials used in such object belong to the same family of thermoplastics, i.e. the materials allow for mechanical recycling via melt processing of the thermoplastics with minimised down-cycling, allowing for manufacture of products of similar value and quality as the original object. Such objects are commonly referred to as mono-material objects or articles.

It is now by the present invention achieved to provide a laminated polyethylene mono-material film that is suitable for a variety of packaging applications, in that the invention provides for a laminated polyethylene film comprising:
(a) a first film; and
(b) a second film;
wherein the first and the second film are adhering to one another to form a laminate; wherein
   the first film is a bi-directionally oriented film; and
   the second film is a blown film;
wherein the first film comprises or consists of polyethylene, and the second film comprises or consists of polyethylene;
wherein the second film comprises one or more film layers, and comprises a sealing layer so that the sealing layer forms a surface layer of the laminated film;
wherein the sealing layer comprises a polyethylene copolymer (I) comprising moieties derived from 1-hexene or 1-octene, preferably from 1-octene, having:
   a density of ≥855 kg/m³ and ≤910 kg/m³, as determined in accordance with ASTM D792 (2008);
   a melt mass-flow rate of ≥0.2 and ≤5.0 g/10 min, as determined in accordance with ASTM D1238 (2013) at a temperature of 190° C. under a load of 2.16 kg.

Such laminated film, constituting a mono-material, mechanically recyclable packaging film solution, demonstrates a desirably low sealing temperature whilst ensuring good seal strength. This enables use in thermally sealed food packages, with reduced sealing energy consumption and reduced exposing of package contents to high temperatures, leading to increase of shelf life of the packed foodstuff. Moreover, the mechanical properties of the laminate are of desirably high level.

The polyethylene that is present in the first film may for example be a linear low-density polyethylene having a density of ≥910 and ≤940 kg/m³, preferably ≥910 and ≤930 kg/m³, more preferably ≥910 and ≤925 kg/m³, even more preferably ≥915 and ≤925 kg/m³. Alternatively, the polyethylene that is present in the first film may for example be a high-density polyethylene having a density of >940 and ≤975 kg/m³, preferably ≥945 and ≤970 kg/m³, more preferably ≥945 and ≤960 kg/m³. Preferably, the polyethylene that is present in the first film is a linear low-density polyethylene.

The linear low-density polyethylene in the first film may for example be a polyethylene comprising moieties derived from ethylene and moieties derived from an olefin selected from 1-butene, 1-hexene and 1-octene. For example, the linear-low density polyethylene in the first film may comprise ≥80.0 and ≤95.0 wt % of moieties derived from ethylene, with regard to the total weight of the linear low-density polyethylene, preferably ≥85.0 wt % and ≤95.0 wt %. For example, the linear-low density polyethylene in the first film may comprise ≥5.0 and ≤20.0 wt % of moieties derived from an olefin selected from 1-butene, 1-hexene and 1-octene, with regard to the total weight of the linear low-density polyethylene, preferably ≥5.0 wt % and ≤15.0 wt %. It is preferred that the olefin is 1-hexene.

The linear low-density polyethylene in the first film may for example have a melt mass-flow rate of ≥0.2 and ≤5.0 g/10 min, as determined in accordance with ASTM D1238 (2013) at a temperature of 190° C. under a load of 2.16 kg, preferably ≥0.5 and ≤5.0 g/10 min, preferably ≥0.5 and ≤3.0 g/10 min, more preferably ≥0.8 and ≤3.0 g/10 min, even more preferably ≤1.0 and ≤3.0 g/10 min, even more preferably ≥1.0 and ≤2.5 g/10 min.

The linear low-density polyethylene in the first film may be characterised by its a-TREF fingerprint, that is, i a particular distribution of the fractions of polymer that in a-TREF are eluted in particular defined temperature ranges in which the fractionation is performed. The linear low-density polyethylene in the first film may for example have a fraction eluted in a-TREF at a temperature >94.0° C. of ≥20.0 wt %, with regard to the total weight of the polyethylene. More preferably, the linear low-density polyethylene in the first film has a fraction eluted >94.0° C. of ≥25.0 wt %, even more preferably ≥30.0 wt %, yet even more preferably ≥35.0 wt %. In the field of polyethylenes, the fraction of polymer that is eluted in a-TREF at a temperature of >94.0° C. reflects the quantity of linear polymeric material that is present in the particular polymer. In the present polymer, having a particular quantity of the material in this fraction, this indicates that a certain amount of linear polymeric material is to be present.

Further, the linear low-density polyethylene in the first film may for example have a fraction that is eluted in a-TREF at a temperature ≤30.0° C. of ≥8.0 wt %, with regard to the total weight of the polyethylene. The fraction that is eluted at a temperature of ≤30° C. may in the context of the present invention be calculated by subtracting the sum of the fraction eluted >94° C. and the fraction eluted >30° C. and ≥94° C. from 100%, thus the total of the fraction eluted ≤30° C., the fraction eluted >30° C. and ≤94° C. and the fraction eluted >94° C. to add up to 100.0 wt %. The fraction eluted ≤30° C. preferably is ≥9.0 wt %, more preferably ≥10.0 wt %, even more preferably ≥11.0 wt %. Preferably, the fraction that is eluted in a-TREF at a temperature ≤30.0° C. is ≥8.0 and ≤16.0 wt %, more preferably ≥9.0 and ≤14.0 wt %, even more preferably ≥10.0 and 14.0 wt % with regard to the total weight of the polymer; and/or preferably, the fraction that is eluted in a-TREF at a temperature >94.0° C. is ≥20.0 and ≤50.0 wt %, more preferably ≥25.0 and ≤45.0 wt %, even more preferably ≥30.0 and ≤40.0 wt %, with regard to the total weight of the polymer; and/or preferably, the fraction that is eluted in a-TREF at a temperature >30.0 and ≤94.0° C. is ≥40.0 and ≤64.0 wt %, more preferably ≥45.0 and ≤60.0 wt %, even more preferably is ≥45.0 and ≤55.0 wt %.

According to the invention, analytical temperature rising elution fractionation, also referred to as a-TREF, may be carried out using a Polymer Char Crystaf-TREF 300 with a solution containing 4 mg/ml of sample prepared in 1,2-dichlorobenzene stabilised with 1 g/l Topanol CA (1,1,3-tri(3-tert-butyl-4-hydroxy-6-methylphenyl)butane) and 1 g/l Irgafos 168 (tri(2,4-di-tert-butylphenyl) phosphite) at a temperature of 150° C. for 1 hour. The solution may be further stabilised for 45 minutes at 95° C. under continuous stirring at 200 rpm before analyses. For analyses, the solution was crystallised from 95° C. to 30° C. using a cooling rate of 0.1° C./min. Elution was performed with a heating rate of 1° C./min from 30° C. to 140° C. The set-up was cleaned at 150° C. Particularly, a-TREF may be carried out using a Polymer Char Crystaf-TREF 300 using a solution containing 4 mg/ml of the polymer in 1,2-dichlorobenzene, wherein the solution is stabilised with 1 g/l 1,1,3-tri(3-tert-butyl-4-hydroxy-6-methylphenyl)butane and 1 g/l tri(2,4-di-tert-butylphenyl) phosphite) at a temperature of 150° C. for 1 hour, and optionally further stabilised for 45 minutes at 95° C. under continuous stirring at 200 rpm, wherein the prior to analyses the solution is crystallised from 95° C. to 30° C. using a cooling rate of 0.1° C./min, and elution is performed at a heating rate of 1° C./min from 30° C. to 140° C., and wherein the equipment has been cleaned at 150° C.

The linear low-density polyethylene in the first film may for example have an M_{w}/Mₙ ratio of >4.0, preferably >4.0 and <10.0, more preferably >5.0 and <8.0. For example, the linear low-density polyethylene in the first film may have an M_{z}/Mₙ ratio of >15.0, preferably >15.0 and <40.0, preferably >20.0 and <30.0, wherein Mₙ is the number average molecular weight, M_{w} is the weight average molecular weight, and M_{z} is the z-average molecular weight, as determined in accordance with ASTM D6474 (2012). For example, the linear low-density polyethylene in the first film may for example have an M_{w}/Mₙ ratio of >4.0, preferably >4.0 and <10.0 and an M_{z}/Mₙ ratio of >15.0, preferably >15.0 and <40.0. It is preferred that in the range of log(M_{w}) between 4.0 and 5.5, the slope of the curve of the number of CH₃ branches per 1000 C atoms versus the log(M_{w}) is negative, wherein the number of CH₃ branches is determined via SEC-DV with and IR5 infrared detector, in accordance with ASTM D6474 (2012). The linear low-density polyethylene in the first film may have an M_{w} of for example >75 kg/mol, preferably >100 kg/mol, such as >75 and <200 kg/mol, preferably >100 and <150 kg/mol. The linear low-density polyethylene in the first film may have an Mₙ of for example >15 kg/mol, preferably >20 kg/mol, such as for example >15 and <40 kg/mol, preferably >20 and <30 kg/mol. The linear low-density polyethylene in the first film may have an M_{z} of >300 kg/mol, preferably >400 kg/mol, such as >300 and <700 kg/mol, preferably >400 and <650 kg/mol. Such characteristics of M_{w}, M_{z} and/or Mₙ may contribute to the improved stretchability of the film.

The high-density polyethylene in the first film may for example have a melt mass-flow rate of ≥0.2 and ≤5.0 g/10 min, as determined in accordance with ASTM D1238 (2013) at a temperature of 190° C. under a load of 2.16 kg, preferably ≥0.5 and ≤5.0 g/10 min, preferably ≥0.5 and ≤3.0 g/10 min, more preferably 0.8 and 3.0 g/10 min, even more preferably 1.0 and 3.0 g/10 min, even more preferably 1.0 and 2.5 g/10 min.

The first film may for example comprise ≥80.0 wt %, preferably ≥90.0 wt %, more preferably ≥95.0 wt %, even more preferably ≥98.0 wt %, of the polyethylene.

The polyethylene copolymer (I) preferably has a density of ≥870 and≤910 kg/m³, preferably of ≥880 and 910 kg/m³, more preferably of ≥890 and ≤910 kg/m³, even more preferably of ≥895 and 905 kg/m³. The use of a polyethylene copolymer having such density contributes to improved sealing.

The polyethylene copolymer (I) preferably has a fraction of material that is eluted in a-TREF at a temperature of ≤30.0° C. of ≥5.0 wt % with regard to the total weight of the polyethylene, preferably ≥7.5 wt %, more preferably ≥10.0 wt %, even more preferably ≥11.5 wt %. Preferably, the polyethylene copolymer (I) has a fraction of material that is eluted in a-TREF at a temperature of ≤30.0° C. of ≥5.0 wt % and ≤25.0 wt %, more preferably ≥7.5 wt % and ≤20.0 wt %, even more preferably ≥10.0 wt % and ≤20.0 wt %, even more preferably ≥11.0 wt % and ≤15.0 wt %, with regard to the total weight of the polyethylene. The use of a polyethylene copolymer having such a fraction of material that is eluted in a-TREF at a temperature of ≤30.0° C. contributes to a reduction of the seal initiation temperature.

The polyethylene copolymer (I) preferably has a shear storage modulus G′ determined at a shear loss modulus G″=5000 Pa of >1000 Pa, preferably >1100 Pa, more preferably >1200 Pa, even more preferably >1300 Pa. The use of a polyethylene copolymer having such shear storage modulus G′ at a shear loss modulus of 5000 Pa contributes to improved processability of the film.

For determination of the shear storage modulus G′ and the shear loss modulus G″, specimens may be used as prepared in accordance with ISO 17855-2 (2016). The DMS measurements were carried out according to ISO 6721-10 (2015) at 190° C. Determination of G′ at G″=5000 Pa may be done by preparation of a double-logarithmic Cole-Cole plot of G′ and G″, where above and below G″=5000 Pa, each 2 data points are to be selected, so in total 4 data points, and a first order line may be determined, where from this line G′ at G″=5000 Pa is determined.

The polyethylene copolymer (I) preferably has a melt mass-flow rate, determined at 190° C. under a load of 2.16 kg (MFR2), in accordance with ASTM D1238 (2013), of ≥0.2 and ≤4.0 g/10 min, preferably ≥0.5 and ≤3.0 g/10 min, more preferably ≥0.5 and ≤2.5 g/10 min. Such polyethylene copolymer allows for manufacturing of films with appropriate melt stability and processability.

The polyethylene copolymer (I) may for example have a chemical composition distribution broadness (CCDB) of ≥15.0, preferably ≥20.0, wherein the CCDB is determined according to formula I:

$$CCDB = \frac{{T}_{z + 2} - {T}_{n - 2}}{{T}_{n - 2}} * 100 \qquad formula I$$

wherein
   Tₙ₋₂ is the moment calculated according to the formula II:

$${T}_{n - 2} = \frac{\sum \frac{w ( i )}{{T ( i )}^{2}}}{\sum \frac{w ( i )}{{T ( i )}^{3}}} \qquad formula II$$

and
   T_{z+2} is the moment calculated according to the formula III:

$${T}_{z + 2} = \frac{\sum w ( i ) \cdot {T ( i )}^{4}}{\sum w ( i ) \cdot {T ( i )}^{3}} \qquad formula III$$

wherein
   w(i) is the sampled weight fraction in wt % with regard to the total sample weight in a-TREF analysis of a sample (i) taken at temperature T(i), where T(i) >30° C., the area under the a-TREF curve being normalised to surface area=1 for T(i)>30° C.; and
   T(i) is the temperature at which sample (i) is taken in a-TREF analysis, in ° C.

The polyethylene copolymer (i) may for example have a CCDB of ≥15.0, preferably ≥17.5, more preferably ≥20.0. For example, the polyethylene copolymer (I) may have a CCDB of ≥15.0 and ≤30.0, preferably ≥17.5 and ≤25.0, more preferably ≥20.0 and ≤25.0, or ≥20.0 and ≤30.0. The use of a polyethylene copolymer having such CCDB contributes to an improved seal strength.

It is preferred that the first film is oriented is both machine and transverse direction in the solid state, preferably wherein the first film is oriented at a drawing ratio of ≥3.0, preferably ≥3.0 and ≤15.0 in the machine direction, and/or at a drawing ratio of ≥3.0, preferably ≥3.0 and ≤15.0 in the transverse direction, wherein the drawing ratio is defined as the dimension of the film in the particular direction after being subjected to the orientation step, divided by the dimension of the film in the particular direction prior being subjected to the orientation step.

In the laminate polyethylene film according to the present invention, the second film may for example be a single-layer or a multi-layer film obtained by multi-layer melt co-extrusion.

The sealing layer comprised in the second film may for example comprise the polyethylene copolymer (I), linear low-density polyethylene (LLDPE) (II) and optionally low-density polyethylene (LPDE) (Ill), preferably wherein the sealing layer comprises ≥10.0 wt %, preferably ≥20.0 wt %, more preferably ≥40.0 wt %, of the polyethylene copolymer (I). It is preferred that the sealing layer comprises ≥20.0 wt % and ≤80.0 wt % of the polyethylene copolymer (I), ≥10.0 wt % and ≤70.0 wt % of the LLDPE (II), and ≤20.0 wt % of the LDPE (III), with regard to the total weight of the sealing layer. More preferably, the sealing layer comprises ≥30.0 wt % and ≤80.0 wt % of the polyethylene copolymer (I), ≥10.0 wt % and ≤70.0 wt % of the LLDPE (II), and ≤15.0 wt % of the LDPE (III), with regard to the total weight of the sealing layer. Even more preferably, the sealing layer comprises ≥50.0 wt % and ≤80.0 wt % of the polyethylene copolymer (I), ≥10.0 wt % and ≤50.0 wt % of the LLDPE (II), and ≤15.0 wt % of the LDPE (III), with regard to the total weight of the sealing layer. Yet even more preferably, the sealing layer comprises ≥50.0 wt % and ≤80.0 wt % of the polyethylene copolymer (I), ≥10.0 wt % and ≤45.0 wt % of the LLDPE (II), and ≥5.0 and ≤15.0 wt % of the LDPE (III), with regard to the total weight of the sealing layer. Yet even more preferably, the sealing layer comprises ≥60.0 wt % and ≤80.0 wt % of the polyethylene copolymer (I),≥10.0 wt % and ≤35.0 wt % of the LLDPE (II), and ≥5.0 and ≤15.0 wt % of the LDPE (III), with regard to the total weight of the sealing layer.

In such embodiments of the invention wherein the second film is a multi-layer film, the second film may for example comprise a first layer, optionally a second layer, and a sealing layer. It is preferred that the second film is adhered to the first film with that surface of the second film formed by the first layer. The first layer and/or the second layer may for example comprise LLDPE (II) and optionally LDPE (III), preferably ≥80.0 wt % of the LLDPE (II), with regard to the total weight of the first layer, more preferably the first layer comprises the LLDPE (II) and the optional LDPE (III) as the only polymer materials in the particular layer. The LLDPE (II) in the first layer and the LLDPE (II) in the sealing layer may be the same or different, and/or the LDPE (III) in the first layer and the LDPE (III) in the sealing layer may be the same or different.

The LLDPE (II) may for example be a polyethylene copolymer comprising moieties derived from ethylene and moieties derived from one or more of 1-butene, 1-hexene and 1-octene, preferably ≥75.0 wt % of moieties derived from ethylene and/or ≤25.0 wt % of moieties derived from one or more of 1-butene, 1-hexene and 1-octene, with regard to the total weight of the LLDPE (II), preferably wherein the LLDPE (II) has a density of ≥910 and ≤940 kg/m³ and a melt mass-flow rate of ≥0.2 and ≤5.0 g/10 min, as determined in accordance with ASTM D1238 (2013) at a temperature of 190° C. under a load of 2.16 kg.

The LDPE (III) may for example be an ethylene polymer obtained by free-radical polymerisation, preferably high-pressure free-radical polymerisation, and has a density of ≥910 and ≤940 kg/m³, preferably of ≥920 and ≤930 kg/m³, and a melt mass-flow rate of ≥0.2 and ≤15 5.0 g/10 min, preferably of ≥0.4 and ≤2.0 g/10 min, as determined in accordance with ASTM D1238 (2013) at a temperature of 190° C. under a load of 2.16 kg.

It is also preferred that the first and the second film of the laminate polyethylene film comprise no polymer materials other than polymers comprising only polymer moieties derived from ethylene and mono-olefins comprising ≥3 and ≤12 carbon atoms.

The first film may for example have a thickness of ≥10 and ≤150 μm, preferably of ≥10 and ≤100 μm, more preferably ≥20 and ≤70 μm. The second film may for example have a thickness of ≥10 and ≤150 μm, preferably ≥10 and ≤100 μm, more preferably ≥20 and ≤70 μm. The laminated polyethylene film may for example have a thickness of ≥20 and ≤300 μm, preferably of ≥40 and ≤200 μm, more preferably ≥60 and ≤150 μm.

The present invention, in a certain embodiment, also relates to a package comprising the laminate polyethylene film. For example, the package may be a heat-sealed bag.

The invention also relates in certain of its embodiments to a process for manufacturing a sealed bag, the process involving subjecting an assembly comprising a first and a second part of the laminate polyethylene film assembled so that both sealing layers face each other, and subjecting at least a part the assembly to an energy treatment, such as a heat treatment, whilst pressing the parts together so that, termination of the energy treatment, a seal is formed closing the assembly so as to form a sealed bag.

The invention will now be illustrated by the following non-limiting examples.

The following materials were used in the examples demonstrating the present invention:

| | |
|---|---|
| BOPE | SABIC LLDPE BX202, MFR2: 2.1 g/10 min; |
| | density: 921 kg/m³ |
| Polyethylene | SABIC COHERE S100L, MFR2: 1.0 g/10 min; |
| copolymer | density 900 kg/m³ |
| (Co-PE) (I) | |
| LLDPE (II) | SABIC 118WJ, MFR2: 1.0 g/10 min; |
| | density 918 kg/m³ |
| LDPE (III) | SABIC HP0823, MFR2: 0.8 g/10 min; |
| | density 923 kg/m³ |

Wherein the MFR2 is the melt mass flow rate as determined in accordance with ASTM D1238

(2013) ata temperature of 190° C. under a load of 2.16 kg, and the density is as determined in accordance with ASTM D792 (2008).

First film: A bi-directionally oriented (BOPE) film was produced as 3-layer film using the BOPE material as above. The bi-directionally oriented film was produced in a cast film production line with subsequent sequential biaxial orientation. A set-up comprising three melt extruders was used, where an extruder A supplied material for a first skin layer A, an extruder B supplied material for inner layer B, and an extruder C supplied the material for the second skin layer C. The extruders were positioned such that the molten material was forced through a t-shaped die with a die gap of 3.0 mm, so that the arrangement of the layers in the obtained cast film was A/B/C. Each of the extruders A, B and C was operated such to supply molten polymer material at a temperature of 260° C. The die temperature was 260° C.

The film as extruder through the t-shaped die was cast onto a chill roll to form a cast film having a thickness of about 840 μm.

The chilled cast film was subjected to stretching in the machine direction using a set of stretching rolls at a temperature of 98° C., followed by an annealing at 80° C., to induce a degree of stretching in the machine direction of 4.6.

Subsequently, the film was stretched in the transverse direction to a degree of stretching of 9.0 by subjecting the film to heat whilst applying a stretching force, wherein the film was passed through an oven through which the film was continuously transported, wherein the temperature was 140° C. at the entering zone of the oven, decreasing to 100° C. towards the exit of the oven. The skin layer C was subsequently subjected to a corona treatment of 25 W·min/m². Bi-directionally oriented 3-layer films having a thickness of 30 μm were obtained.

Second film: 3-layer blown films were produced according to the layer formulations as exhibited in the table below. The films were produced using a Wuhan Jingji blown film line. The obtained film has a thickness of 50 μm, and a layer distribution A/B/C of 1/2/1 (weight ratio). Layer A was the first layer, layer B the second layer, and layer C the sealing layer. The layer A was subjected to a corona treatment. The blow-up ratio was 2.5 for all blown films as produced. The line was operated at a line speed of 17 m/min, using an extruder temperature profile for each of the zones and a speed in RPM as indicated below:

| | | | | | | | Extruder |
|---|---|---|---|---|---|---|---|
| | Zone temperature (° C.) | | | | | | speed |
| Extruder | I | II | III | IV | V | VI | RPM |
| A | 175 | 190 | 190 | 190 | 190 | 185 | 50 |
| B | 175 | 190 | 190 | 190 | 190 | 185 | 53 |
| C | 175 | 190 | 190 | 190 | 190 | 185 | 60 |

Formulations for blown films:

| | | Formulation (in wt % w.r.t. weight of layer) | | |
|---|---|---|---|---|
| Blown Film | Layer | Co-PE (I) | LLDPE (II) | LDPE (III) |
| B1 | A | | 80 | 20 |
| | B | | 80 | 20 |
| | C | | 90 | 10 |
| B2 | A | | 80 | 20 |
| | B | | 80 | 20 |
| | C | 20 | 70 | 10 |
| B3 | A | | 80 | 20 |
| | B | | 80 | 20 |
| | C | 40 | 50 | 10 |
| B4 | A | | 80 | 20 |
| | B | | 80 | 20 |
| | C | 70 | 20 | 10 |

Using the BOPE films and the above produced blown films B1-B4, laminates were produced using a Nordmeccanica simplex solventless laminator, using Henkel Loctite Liofol LA7758/LA6011 as solventless adhesive. Laminates were formed by adhering layer A of the second film to the BOPE film. Properties of the obtained laminates were determined, the results of which are presented below.

| Sample | L1 | L2 | L3 | L4 |
|---|---|---|---|---|
| Structure | BOPE/B1 | BOPE/B2 | BOPE/B3 | BOPE/B4 |
| Secant modulus 1% | 296 | 308 | 297 | 284 |
| (MD) (MPa) | | | | |
| Tensile strength at | 30.7 | 29.9 | 29.8 | 29.9 |
| break (MD) (N/mm²) | | | | |
| Elongation at break | 254 | 257 | 273 | 251 |
| (MD) (%) | | | | |
| Puncture force at | 191 | 187 | 187 | 203 |
| break (N) | | | | |
| Puncture energy at | 3.1 | 3.1 | 3.1 | 3.3 |
| break (J) | | | | |
| Dart impact resistance | 6.9 | 7.6 | 8.1 | 7.3 |
| (g/μm) | | | | |
| Tear resistance (MD) | 1.6 | 1.4 | 1.4 | 1.2 |
| (g/μm) | | | | |
| Tear resistance (TD) | 1.4 | 1.3 | 1.2 | 1.2 |
| (g/μm) | | | | |
| Flex crack resistance | 4.5 | 6.8 | 6.5 | 5.5 |

Wherein:
The secant modulus is the 1% secant modulus as determined in accordance with ASTM D882 (2012);
The tensile strength at break is determined in accordance with ASTM D882 (2012) at room temperature using an initial sample length of 50 mm and a testing speed of 500 mm/min;
The elongation at break is determine in accordance with ASTM D882 (2012) at room temperature using an initial sample length of 50 mm and a testing speed of 500 mm/min;
The puncture force at break and puncture energy at break were determined in accordance with ASTM D5748-95 (2012);
The dart impact resistance is determined as impact failure weight in accordance with ASTM D1709 (2016), method B, at room temperature, expressed in grams per unit of film thickness;
The tear resistance is determined as Elmendorf tear resistance in accordance with ASTM D1922 (2015);
The flex crack resistance is presented as the pinhole count occurring on a sample per 300 cm³ after 21600 cycles when tested in accordance with ASTM F392-93 (2004);
MD indicates machine direction, i.e. the direction in which the film is extruded in the cast film extrusion process, TD indicates transverse direction, i.e. the direction perpendicular to the machine direction.

Furthermore, a number of sealing properties were determined as set out below.

The heat seal strength was determined in accordance with ASTM F88, using method A, on specimens of 15 mm width. Fin-seals were prepared according to ASTM F2029 at different temperatures. Two samples of the same film were compressed together, with layer C of the first film sample contacting layer C of the second film sample. Seals were produced by applying a force of 3.0 bar for 0.5 sec, wherein the films were protected with a 12 μm BOPET sheet. The press used for preparing the seal was heated to various temperatures to identify the strength of the seal when produced at different temperatures.

The seal strength was tested using a tensile testing machine with a testing speed of 200 mm/min, and a grip distance of 10 mm. The maximum load was recorded as the seal strength.

The results of seal strength testing of films of the various above examples, sealed at varying temperatures, are presented in the table below.

| | Seal strength at | | | | | | | | |
|---|---|---|---|---|---|---|---|---|---|
| Example | 80° C. | 85° C. | 90° C. | 95° C. | 100° C. | 105° C. | 110° C. | 115° C. | 120° C. |
| L1 | 0 | 0 | 0 | 0 | 0 | 2 | 4 | 22 | 26 |
| L2 | 0 | 0 | 1 | 2 | 4 | 19 | 23 | 24 | 29 |
| L3 | 0 | 1 | 2 | 6 | 18 | 21 | 23 | 25 | 31 |
| L4 | 4 | 10 | 17 | 18 | 22 | 24 | 27 | 31 | 32 |

Further, the hot tack strength of the films was determined. Determination thereof was conducted in accordance with ASTM F1921, method B on 15 mm width specimens, with layer C against layer C. The seal pressure was 0.3 N/mm², and the dwell time 0.5 sec. The delay time was 300 ms and the clamp separation rate was 200 mm/s. The hot tack strength is expressed in N/15 mm width.

| | Hot tack strength at | | | | | | | |
|---|---|---|---|---|---|---|---|---|
| Example | 70° C. | 80° C. | 90° C. | 100° C. | 110° C. | 120° C. | 130° C. | 140° |
| L1 | | | 0.2 | 0.6 | 1.5 | 2.7 | 2.0 | 1.3 |
| L2 | | 0.3 | 2.2 | 2.4 | 2.8 | 2.1 | 1.5 | 1.1 |
| L3 | | 0.5 | 2.4 | 2.3 | 2.4 | 2.5 | 1.8 | 1.3 |
| L4 | 0.4 | 2.5 | 3.3 | 3.7 | 3.4 | 3.1 | 1.9 | 1.3 |

1. Laminated polyethylene film comprising:
(a) a first film; and
(b) a second film;
wherein the first and the second film are adhering to one another to form a laminate;
wherein
the first film is a bi-directionally oriented film; and
the second film is a blown film;
wherein the first film comprises or consists of polyethylene, and the second film comprises or consists of polyethylene;
wherein the second film comprises one or more film layers, and comprises a sealing layer so that the sealing layer forms a surface layer of the laminated film;
wherein the sealing layer comprises a polyethylene copolymer (I) comprising moieties derived from 1-hexene or 1-octene having:
a density of ≥855 kg/m³ and ≤910 kg/m³, as determined in accordance with ASTM D792 (2008);
a melt mass-flow rate of ≥0.2 and ≤5.0 g/10 min, as determined in accordance with ASTM D1238 (2013) at a temperature of 190° C. under a load of 2.16 kg.

2. Laminate polyethylene film according to claim 1, wherein the polyethylene that is present in the first film is:
a linear low-density polyethylene having a density of ≥910 and ≤940 kg/m³; or
a high-density polyethylene having a density of >940 and ≤975 kg/m³.

3. Laminate polyethylene film according to claim 1, wherein the first film is oriented in both machine and transverse direction in the solid state.

4. Laminate polyethylene film according to claim 1, wherein the second film is a single-layer or a multi-layer film obtained by multi-layer melt co-extrusion.

5. Laminate polyethylene film according to claim 1, wherein the sealing layer comprised in the second film comprises the polyethylene copolymer (I), linear low-density polyethylene (LLDPE) (II).

6. Laminate polyethylene film according to claim 1, wherein the second film is a multi-layer film comprising a first layer, optionally a second layer, and a sealing layer.

7. Laminate polyethylene film according to claim 6, wherein the second film is adhered to the first film with that surface of the second film formed by the first layer.

8. Laminate polyethylene film according to claim 6, wherein the first layer and/or the second layer comprises LLDPE (II).

9. Laminate polyethylene film according claim 8, wherein the LLDPE (II) in the first layer and LLDPE (II) in the sealing layer are the same or different, and/or wherein LDPE (III) in the first layer and LDPE (III) in the sealing layer are the same or different.

10. Laminate polyethylene film according to claim 5, wherein the LLDPE (II) is a polyethylene copolymer comprising moieties derived from ethylene and moieties derived from one or more of 1-butene, 1-hexene and 1-octene, with ≥75.0 wt % of moieties derived from ethylene and/or ≤25.0 wt % of moieties derived from one or more of 1-butene, 1-hexene and 1-octene, with regard to the total weight of the LLDPE (II), and wherein the LLDPE (II) has a density of ≥910 and ≤940 kg/m³ and a melt mass-flow rate of ≥0.2 and ≤5.0 g/10 min, as determined in accordance with ASTM D1238 (2013) at a temperature of 190° C. under a load of 2.16 kg.

11. Laminate polyethylene film according to claim 5, wherein the LDPE (III) is an ethylene polymer obtained by free-radical polymerisation, and/or high-pressure free-radical polymerisation, and has a density of ≥910 and ≤940 kg/m³ and a melt mass-flow rate of ≥0.2 and ≤5.0 g/10 min, as determined in accordance with ASTM D1238 (2013) at a temperature of 190° C. under a load of 2.16 kg.

12. Laminate polyethylene film according to claim 1,wherein the first and the second film of the laminate polyethylene film comprise no polymer materials other than polymers comprising only polymer moieties derived from ethylene and mono-olefins comprising ≥3 and ≤12 carbon atoms.

13. Package comprising the laminate polyethylene film according to claim 1.

14. Package according to claim 14 wherein the package is a heat-sealed bag.

15. Process for manufacturing a sealed bag, the process involving subjecting an assembly comprising a first and a second part of the laminate polyethylene film assembled so that both sealing layers face each other, and subjecting at least a part of the assembly to an energy treatment and/or a heat treatment, whilst pressing the parts together so that, termination of the energy treatment, a seal is formed closing the assembly so as to form a sealed bag.

16. Laminate polyethylene film according to claim 1, wherein the sealing layer comprises a polyethylene copolymer (I) comprising moieties derived from 1-octene.

17. Laminate polyethylene film according to claim 1, wherein the first film is oriented in both machine and transverse direction in the solid state, and wherein the first film is oriented at a drawing ratio of ≥3.0 in the machine direction, and wherein the first film is oriented at a drawing ratio of ≥3.0 in the transverse direction, wherein the drawing ratio is defined as the dimension of the film in the particular direction after being subjected to the orientation step, divided by the dimension of the film in the particular direction prior being subjected to the orientation step.

18. Laminate polyethylene film according to claim 1, wherein the first film is oriented in both machine and transverse direction in the solid state, and wherein the first film is oriented at a drawing ratio of ≥3.0 and ≤15.0 in the machine direction, and wherein the first film is oriented at a drawing ratio of ≥3.0 and ≤15.0 in the transverse direction, wherein the drawing ratio is defined as the dimension of the film in the particular direction after being subjected to the orientation step, divided by the dimension of the film in the particular direction prior being subjected to the orientation step.

19. Laminate polyethylene film according to claim 1, wherein the sealing layer comprised in the second film comprises the polyethylene copolymer (I), linear low-density polyethylene (LLDPE) (II) and low-density polyethylene (LPDE) (III), and wherein the sealing layer comprises ≥10.0 wt %, or ≥20.0 wt %, or ≥40.0 wt %, of the polyethylene copolymer (I).

20. Laminate polyethylene film according to claim 6, wherein the first layer and/or the second layer comprises LLDPE (II) and LDPE (III), and comprises ≥80.0 wt % of the LLDPE (II), with regard to the total weight of the first layer, or wherein the first layer comprises the LLDPE (II) and the LDPE (III) as the only polymer materials in the particular layer.
